(19) United States
(12) Patent Application Publication
(10) Pub. No.: US 2010/0011047 A1
(43) Pub. Date: Jan. 14, 2010

(54) Hardware-Based Cryptographic Accelerator

(75) Inventors: David Jackson, Escondido, CA (US); John Andolina, Vista, CA (US)

Correspondence Address: TOWNSEND AND TOWNSEND AND CREW LLP;VIASAT, INC. (CLIENT #017018), TWO EMBARCADERO CENTER, 8TH FLOOR, SAN FRANCISCO, CA, 94111, US

(73) Assignee: ViaSat, Inc., Carlsbad, CA (US)

(21) Appl. No.: 12/499,006

(22) Filed: Jul. 7, 2009

Related U.S. Application Data
(60) Provisional application No. 61/079,406, filed on Jul. 9, 2008.

(51) Int. Cl. G06F 7/52; G06F 7/50; H04L 9/00

(52) U.S. Cl. 708/491; 380/277; 708/620; 708/670; 380/28

(57) ABSTRACT

A system, method, and apparatus for performing hardware-based cryptographic operations are disclosed. The apparatus can include an encryption device with a hardware accelerator having an accumulator, a multiplier circuit, an adder circuit, and a state machine. The state machine can control successive operation of the hardware accelerator to carry out a rapid, multiplier-based reduction of a large integer by a prime modulus value. Optionally, the hardware accelerator can include a programmable logic device such as a field-programmable gate array with one or more dedicated multiple-accumulate blocks.

### CROSS-REFERENCE TO RELATED APPLICATIONS

This application claims the benefit of and is a non-provisional of U.S. provisional patent application 61/079,406, titled “Modular Reduction Method for Hardware Implementation” and filed on Jul. 7, 2008 (atty. docket no. 017018-018300), which is assigned to the assignee hereof and incorporated herein by reference for all purposes.

### BACKGROUND

Data encryption is an important part of networked computing. By encrypting data, a sender is able to communicate securely with a recipient over a possibly insecure path. Encryption also provides a means for identifying the parties to a communication. Public key cryptography and digital certificates are examples of these functions and both are now widely used in public and private computer networks.

As computing power has increased, so has the need for stronger and faster encryption. It is not uncommon for many thousands of arithmetic and logic operations to be performed when exchanging encrypted data. These operations can place a heavy burden on computing resources and may reduce the performance of network devices.

In some cases, general purpose computing equipment is used for data encryption. Encryption algorithms that are implemented in software can be slow and may interrupt other processing tasks. This can create bottlenecks which, in turn, can reduce overall system performance. In other cases, encryption can be performed in hardware. However, encryption hardware can be highly complex and expensive.

### BRIEF SUMMARY

A system, method, and apparatus for performing hardware-based cryptographic operations are disclosed. The apparatus can include an encryption device with a hardware accelerator having an accumulator, a multiplier circuit, an adder circuit, and a state machine. The state machine can control successive operation of the hardware accelerator to carry out a rapid, multiplier-based reduction of a large integer by a prime modulus value. Optionally, the hardware accelerator can include a programmable logic device such as a field-programmable gate array with one or more dedicated multiple-accumulate blocks.

In one embodiment, a hardware accelerator is disclosed. The hardware accelerator includes an accumulator which can store a plurality of bits of a large integer corresponding to a multiply operation of the hardware accelerator. The plurality of bits includes first bits and second bits. A first multiplexer receives the first bits of the accumulator at one input and can supply a first value at its output. A multiplier circuit can generate a product by multiplying the first value by a modular reduction constant corresponding to a prime modulus value. An adder circuit can add the second bits of the accumulator to the product to produce a sum. The sum can be stored in the accumulator. A state machine is coupled to select input of the first multiplexer and can control a successive operation of the multiplier circuit and the adder circuit. The state machine can determine when a value of the accumulator comprises a modular reduction of the large integer by the prime modulus value.

In another embodiment, a method of accelerating cryptographic operations with a programmable logic device having multiplier, adder, and accumulator circuits is disclosed. The method includes multiplying two large integer values with the multiplier circuit and storing a result of the multiplication in the accumulator. The method also includes receiving a modular reduction constant corresponding to a prime modulus value and selecting first bits of the accumulator based on a size of the prime modulus value. The method includes multiplying the first bits by the modular reduction constant and adding second bits of the accumulator thereto in a first operation. The method includes storing a result of the first operation in the accumulator. The method includes selecting first bits of the accumulator based on the size of a prime modulus value. The method includes multiplying the first bits by the modular reduction constant and adding second bits of the accumulator thereto in a second operation. The method includes storing a result of the second operation in the accumulator and comparing the prime modulus value to the accumulator. The method includes subtracting the prime modulus value from the accumulator when a value of the accumulator is larger than the prime modulus value.

In another embodiment, a programmable logic device is disclosed. The device includes a dedicated multiply-accumulate circuit. A first multiplexer is coupled to a first input of the multiply-accumulate circuit and can receive high-order bits of a large integer at one input. A second multiplexer is coupled to a second input of the multiply-accumulate circuit and can receive low-order bits of the large integer value at one input. A state machine is coupled to select inputs of the first and second multiplexers and can select the high-order bits and the low-order bits. The state machine can direct a first operation of the multiply-accumulate circuit to produce an accumulated value by multiplying the high-order bits by a modular reduction constant and adding a product of the multiply to the low-order bits. The state machine can direct a second operation of the multiply-accumulate circuit to multiply first selected bits of the accumulated value by the modular reduction constant and to add second selected bits of the accumulated value to the result.

In another embodiment, a pipelined hardware accelerator circuit is disclosed. The circuit includes an input/output interface which receives first and second large integers and a modular reduction constant. A first pipeline stage is coupled to the input/output interface and includes a dedicated multiplier circuit which can generate an output by multiplying the first large integer by the second large integer. A second pipeline stage is coupled to the first pipeline stage and to the input/output interface and includes a dedicated multiplier circuit which can generate an output by multiplying a first part of the output of the first pipeline stage by the modular reduction constant. A third pipeline stage is coupled to the first and second pipeline stages and includes an adder circuit which can generate an output by adding a second part of the output of the first pipeline stage to the output of the second pipeline stage. A fourth pipeline stage is coupled to the third pipeline stage and the input/output interface and includes a dedicated multiplier circuit which can generate an output by multiplying a first portion of the output of the third pipeline stage by the modular reduction constant. A fifth pipeline stage is coupled to the third and fourth pipeline stages and includes an adder circuit which can add the output of the fourth pipeline stage to a second portion of the output of the third pipeline stage.

In yet another embodiment, a cryptographic accelerator is disclosed. The accelerator includes means for dividing a large integer into a first part and a second part based on a size of a modulus value. The accelerator includes means for multiplying, in a first multiplication, the first part of the large integer value by a modular reduction constant obtained from the modulus value. The accelerator includes means for adding, in a first addition, the second part of the large integer value to a result of the first multiplication and means for storing a result of the first addition. The accelerator includes means for selecting first bits of the stored result based on the size of the modulus value and means for multiplying, in a second multiplication, the selected first bits by the modular reduction constant. The accelerator includes means for selecting second bits of the stored result based on the size of the modulus value and means for adding, in a second addition, the selected second bits to a result of the second multiplication. The accelerator includes means for subtracting one or more times the modulus value from a result of the second addition when the result of the second addition exceeds the modulus value.

### BRIEF DESCRIPTION OF THE DRAWINGS

FIG. 1 is a diagram showing an embodiment of a secure communication system.

FIG. 2 is a block diagram of one embodiment of an encryption device.

FIG. 3 is a flowchart depicting an embodiment of a process such as can be performed by an encryption device.

FIG. 4 is a schematic diagram of an embodiment of a hardware accelerator.

FIG. 5 is a flowchart depicting an embodiment of a process such as can be performed by a hardware accelerator.

FIG. 6 is a diagram showing aspects of a multiplier-based modular reduction.

FIG. 7 is a block diagram of a further embodiment of a hardware accelerator.

In the figures, similar components and/or features may have the same reference label. Also, various components of the same type may be distinguished by following the reference label with a dash and a second label used to distinguish among the similar components. If only the first reference label is used, the description is applicable to any of the similar components designated by the first reference label.

### DETAILED DESCRIPTION OF EMBODIMENTS

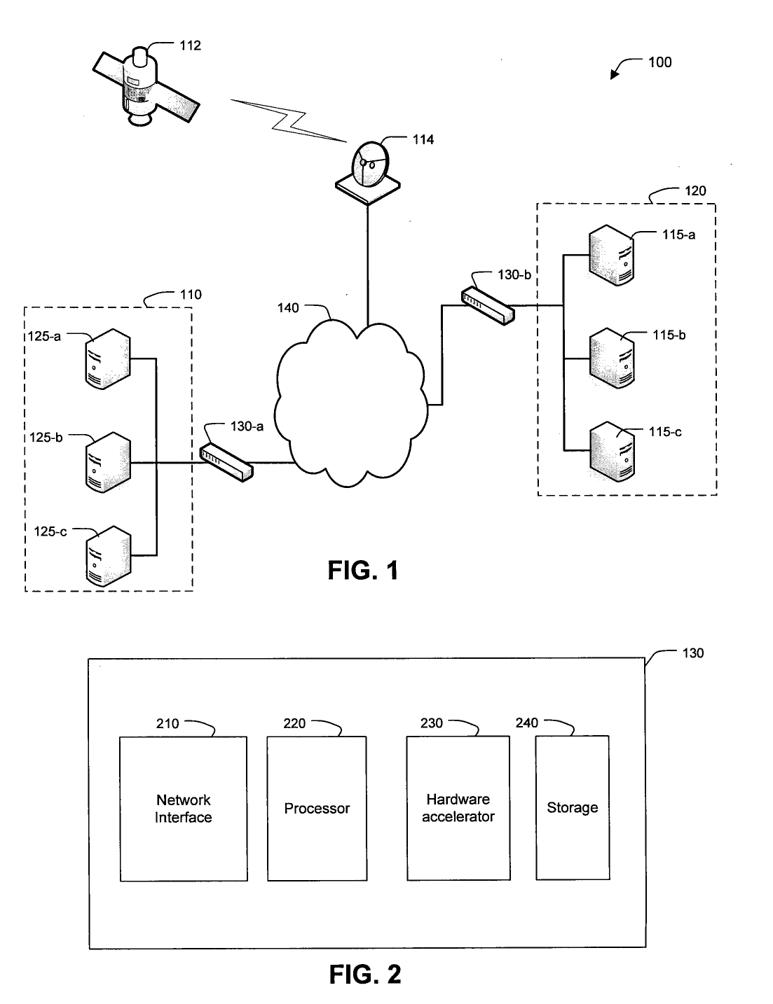

FIG. 1 is a high-level diagram of a secure computing system 100. As shown, two networks 110, 120 communicate through a connecting network 140. For example, network 110 can be a local area network (LAN) or a wide-area network (WAN) having servers 125-a, 125-b, and 125-c which carry communications for other networked devices. Network 120 can also be a LAN/WAN with servers 115-a, 115-b, 115-c which carry data for its devices. Connecting network 140 can be a public or private network. In one embodiment, connecting network 140 is the Internet. Satellite 112 communicates over network 140 via a ground station 114.

Network encryption devices 130-a, 130-b receive communications from networks 110, 120 and can encrypt, decrypt, authenticate, and perform other cryptographic operations for securing the communications of computers 115, 125. An encryption device 130 can also be located on satellite 112 to enable secure communications with servers 115, 125. For example, servers 115, 125 can send encrypted communications over network 140 for controlling the operation of satellite 112.

Among other functions, encryption devices 130 can set up HAIPE (High Assurance Internet Protocol Encryptor) security associations and can support asymmetric key algorithms. Examples of encryption devices 130 include HAIPE devices such as the AltaSec® line of high-speed IP network encryptors from ViaSat Corporation of Carlsbad, Calif. Encryption devices 130 can also include embeddable encryption products such as used in the PSIAM® crypto system also from ViaSat Corporation.

FIG. 2 is a block diagram of one embodiment of encryption device 130. As shown, encryption device 130 includes a network interface 210, a processor 220, a hardware accelerator 230, and a storage medium 240. Network interface 210 can support connections between local and/or wide area networks 110, 120 and connecting network 140. In some embodiments, the LAN/WAN is a private network and the connecting network is a public network. For example, network interface 210 can provide connections through which servers 115, 125 exchange data over internet 140.

Processor 220 directs the operations of encryption device 130 and can include one or more microprocessors, microcontrollers, or like elements capable of executing programmable instructions. Among its functions, processor 220 can implement different networking protocols and can secure various network services to the servers and workstations which are part of its network. These protocols can include TCP (transmission control protocol), UDP (user datagram protocol), and IP (internet protocol). In addition, processor 220 can support ARP (address resolution protocol), dynamic addressing such as DHCP (dynamic host configuration protocol), and other routing or addressing protocols.

Processor 220 is configured to write data to and read data from storage medium 240. Storage medium 240 can include one or more read-only memory (ROM), random-access memory (RAM), or other computer-readable storage media. Storage medium 240 can also include non-volatile devices such as magnetic or optical disk drives. In one embodiment, processor 220 loads program instructions from a memory 240. The program instructions can include encryption algorithms optimized for execution by the encryption device 130. For example, processor 220 can retrieve point doubling, point addition, and other elliptic curve arithmetic algorithms used with elliptic curve cryptography.

Hardware accelerator 230 is coupled to processor 220 and can include one or more field-programmable gate arrays (FPGA), complex programmable logic devices (CPLD), application-specific integrated circuits (ASIC), or other logic devices. Preferably, hardware accelerator 230 includes multiplier, adder, and accumulator circuits as well as logic elements for implementing a state machine or other controller. In one exemplary embodiment, hardware accelerator 230 includes an FPGA with dedicated multiply-accumulate (MACC) function such as the Xilinx Virtex®-4 FPGA, the RTAX-DSP family of products from Actel Corporation, and like devices. Devices such as the RTAX-DSPs, for example, may be used with satellite-based applications such as on board satellite 112.

Processor 220 and hardware accelerator 230 cooperate to perform cryptographic operations such as key agreement. Hardware accelerator 230 can provide a significant performance gain over software-based algorithms by offloading computationally expensive operations such as large integer multiplication and modular reduction. At the same time, because key agreement operations can be divided between processor 220 and hardware accelerator 230, a more efficient hardware implementation is possible. For example, by dividing tasks among the devices, it is not necessary for hardware accelerator 230 to include a complete arithmetic logic unit (ALU) or other highly complex hardware. As a result, encryption device 130 can realize the speed and other efficiencies of hardware implementations while preserving the flexibility and control of software-based devices.

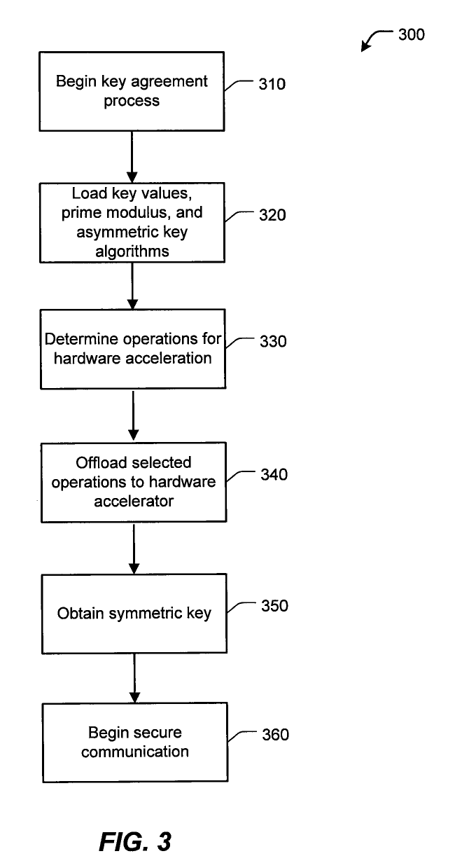

FIG. 3 is a flowchart depicting one embodiment of a key agreement process 300 such as can be performed by encryption device 130. At block 310, the key agreement begins. This can occur in response to communications received at network interface 210. For example, user Alice on network 120 can send a message to user Bob on network 110 requesting secure communications. With asymmetric key algorithms, the request can include Alice's public key or other identifier.

At block 320, encryption device 130 loads information used in the key agreement. For purposes of discussion, a key agreement including an elliptic curve point-multiply operation is described. The point multiply, for example, can involve user Bob's private key and user Alice's public key. A symmetric key based on a result of the point multiplication can be used to encrypt communications passed over network 140. Although a key agreement process is described, it will be understood that encryption device 130 is not limited to a specific cryptographic process or algorithm but can perform various cryptographic operations involving a cooperation between processor 220 and hardware accelerator 230.

At the start of the key agreement, block 320, processor 220 can load the point multiply algorithm along with keying material and a prime modulus value. For example, Alice's public key and Bob's private key can be retrieved from memory 240. Alice's public key can be a point on an elliptic curve and Bob's private key can be a large integer value. In various embodiments, the elliptic curve can be as described in the Federal Information Processing Standards (FIPS) issued by the National Institute of Standards and Technology (NIST). For example, the elliptic curve can be one of the curves mentioned in FIPS 186-2, or some other curve.

Pseudo-code describing an exemplary elliptic-curve point multiply algorithm is provided below. Here, Bob's private key is represented by the large integer, n, and i is used to index a bit position in the private key value. Alice's public key is represented by point A having 384-bit coordinates, and the result of the point multiply by Bob's private key is given as C. During execution of the point-multiply operation, processor 220 can store and retrieve values in memory 240.

Listing 1 - Pseudo code for elliptic curve point multiply

```
Set P=A
First=0
For i=0 to 383
    If nᵢ=1
        If First=0
            Set C=P
            Set First=1
        Else
            Set C=C+P
        EndIf
    EndIf
    P=P+P
End For
```

As the pseudo-code listing demonstrates, elliptic-curve point multiplication can involve a large number of constituent point-doubling and point-addition operations. In the example, a total of 384 point doubling operations (P=P+P) are carried out. Assuming a random distribution of bits in Bob's private key, approximately 192 point additions (C=C+P) will also be required. Since each point-doubling and point-addition can require many large integer multiply and modular reduction operations, the processing task increases rapidly with key size.

At block 330, processor 220 determines a set of operations for hardware accelerator 230. For example, the algorithm retrieved from memory 240 may designate one or more operations to be performed by hardware accelerator 230, or processor 220 may otherwise designate specific operations for acceleration. Processor 220 can create a division of labor in the elliptic curve arithmetic of the point multiply operation and, at block 340, can offload computationally expensive operations to hardware accelerator 230.

In some embodiments, processor 220 offloads large integer multiplication and modular reduction operations to hardware accelerator 230. The exemplary point doubling algorithm of Table 1 illustrates the cooperation between processor 220 and hardware accelerator 230. This algorithm can represent, for example, the P=P+P step in the pseudo-code point multiplication listing above. Here, point P is represented by Jacobian coordinates (X1:Y1:Z1) and the point-doubled result 2P is represented by (X3:Y3:Z3). Point variable T (T1:T2:T3) can be an intermediate value used in the point doubling operation.

TABLE 1
Point doubling algorithm with hardware accelerator

| No. | Operation | Device |
|---|---|---|
| 1. | T₁ ← Z₁² | HA |
| 2. | T₂ ← X₁ − T₁ | P |
| 3. | T₁ ← X₁ + T₁ | P |
| 4. | T₂ ← T₂ · T₁ | HA |
| 5. | T₂ ← 3T₂ | P |
| 6. | Y₃ ← 2Y₁ | P |
| 7. | Z₃ ← Y₃ · Z₁ | HA |
| 8. | Y₃ ← Y₃² | HA |
| 9. | T₃ ← Y₃ · X₁ | HA |
| 10. | Y₃ ← Y₃² | HA |
| 11. | Y₃ ← Y₃/2 | P |
| 12. | X₃ ← T₂² | HA |
| 13. | T₁ ← 2T₃ | P |
| 14. | X₃ ← X₃ − T₁ | P |
| 15. | T₁ ← T₃ − X₃ | P |
| 16. | T₁ ← T₁ · T₂ | HA |
| 17. | Y₃ ← T₁ − Y₃ | P |
| 18. | Return | |
| | (X₃:Y₃:Z₃) | |

As can be seen, the exemplary point double includes 17 operations. Some of the operations, such as addition and subtraction, can readily be performed by processor 220. For example, multiplying Y₁ by 2 in operation 6 can be accomplished by left-shifting the value of Y₁ by one bit position; similarly, dividing Y₃ by 2 in operation 11 can done by right-shifting by one bit position. However, multiplication of large integer values and the corresponding modular reduction of the product to the prime field are computationally intensive and inefficient for execution by processor 220.

Processor 220 can therefore offload large integer multiplication and modular reduction operations to hardware accelerator 230. The device column indicates whether each operation in Table 1 will be performed by the processor (P) or the hardware accelerator (HA). In the exemplary allocation, hardware accelerator 230 would perform operations 1, 4, 7-10, 12, and 16 whereas processor 220 would perform operations 2-3, 5-6, 11, 13-14, and 17. A similar approach can be used to offload large integer multiplications and modular reductions associated with point addition and other cryptographic operations. Of course, many different algorithms and allocations between processor 220 and hardware accelerator 230 are possible within the scope of the present invention.

At block 350, when the calculations are complete, a cryptographic key is obtained. In the example of Alice and Bob, each user would implement the same asymmetric key algorithm at his or her computer yielding the symmetric encryption key. At block 360, encryption device 130 uses the encryption key to encrypt and decrypt network communications.

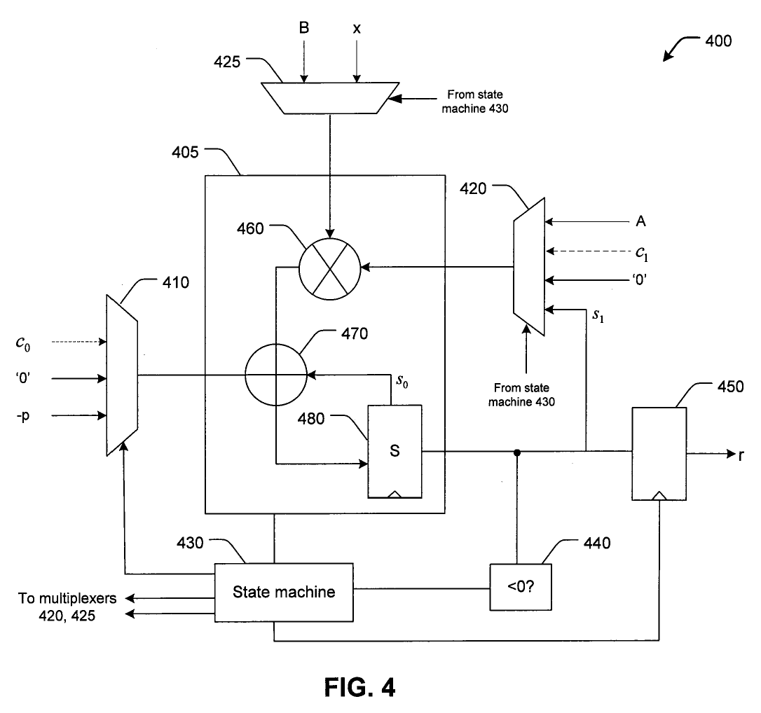

FIG. 4 is a schematic diagram showing one exemplary embodiment of a hardware accelerator 400. Hardware accelerator 400 can operate as described in connection with hardware accelerator 230 and can offload from processor 220 large integer multiplication and modular reduction operations associated with key agreement and other cryptographic processes. Advantageously, hardware accelerator 400 provides a highly efficient multiplier-based approach to modular reduction which can rapidly obtain a result without requiring a complex hardware implementation or recourse to software resources.

In one embodiment, hardware accelerator 400 includes a field-programmable gate array with one or more dedicated multiply-accumulate blocks capable of performing a sequence of multiplication and addition operations and accumulating the result in a highly streamlined manner. However, separate multiplier circuits, adder circuits, and accumulator circuits can also be used. As discussed herein, adders and multipliers can include any series or parallel combination of circuits for performing the corresponding operation. As an example, a 768 bit multiply result can be accomplished with 24 parallel-connected 32-bit multipliers. Alternatively, a small number of series-connected multipliers can be used. Thus, as used herein, the terms multiplier and adder refer to functional hardware elements and not a specific number, size, or arrangement of circuits.

Hardware accelerator 400 includes multiply-accumulate block 405, first multiplexer 410, second multiplexer 420, third multiplexer 425, state machine 430, comparator 440, and latch 450. As shown, multiply-accumulate block 405 includes multiplier 460, adder 470, and accumulator 480. Adder 470 is coupled to first multiplexer 410 for receiving a multi-bit value as determined by state machine 430. Similarly, a first input of multiplier 460 is coupled to second multiplexer 420 and receives its value as determined by state machine 430. A second input of multiplier 460 is coupled to third multiplexer 425 and receives its value as determined by state machine 430. The elements of hardware accelerator 400 can be combined in a single integrated circuit or they may include separate functional elements.

The general operation of multiply-accumulate block 405 can be described as follows. In response to signals from state machine 430, multiplier 460 can multiply the value presented at its first input by the value at its second input and can deliver the product to adder 470. Adder 470 can add the output of multiplexer 410 to the product of the multiply operation and can store the sum in accumulator 480. Some or all of the bits of the accumulated value (so) can be included in the sum. When the operation is complete, state machine 430 can cause the accumulator value to be stored in latch 450 and can signal to processor 220 that the resulting value can be retrieved from latch 450.

More specifically, at the start of a first operation, hardware accelerator 400 can receive two large integer values A, B from processor 220 for multiplication and modular reduction over the field of integers defined by a prime modulus p. Large integer A can be provided at one input of multiplexer 420 and large integer B can be provided at one input of multiplexer 425. State machine 430 can control the operation of multiply-accumulate block 405 by selecting its inputs. Multiplication of A and B is accomplished by selecting the inputs corresponding to the large integers at the multiplexers 420, 425 and performing a multiply-accumulate operation. In this operation, state machine 430 selects a ‘0’ value at one input of first multiplexer 410 as no addition is required. Thus, following the first operation, a result of the large integer multiplication, C, is stored in accumulator 480.

In a next series of operations, hardware accelerator 400 performs a modular reduction of C by the prime modulus p to obtain a result r. The prime modulus value p and its corresponding modular reduction constant, x, can be provided as inputs to the hardware accelerator. In some cases, the number of bits in prime modulus p equals one-half the number of bits of large integer C.

As an example of these operations, let large integer C be a 768-bit number and let prime modulus p be a 384-bit prime value. Prime modulus p, for example, can be determined in advance by the parties to the key agreement and establishes a finite field including all integers from 0 to quantity (p−1). A multiply operation in this field can produce up to a 768-bit value. By modular reduction, the 768-bit number is reduced by p to yield a number in the field which is less than p.

Prime modulus p can be expressed as a binary expansion in the next higher power of two and x can be expressed as a difference between p and a number corresponding to the next highest power. Item (1) shows the expansion of prime modulus p (384 bits) in terms of the next highest power, 2³⁸⁴ (385 bits). The modular reduction constant, x, is expressed as the difference between the prime modulus value and its next highest power (x=2³⁸⁴−p). Item (3) follows from items (1) and (2).

p=2³⁸⁴−2¹²⁸−2⁹⁶+2³²−1 (1)

x=2¹²⁸+2⁹⁶−2³²+1 (2)

2³⁸⁴=x mod p (3)

Since the exemplary large integer C is a 768-bit value, it can be written as the combination of two 384-bit values, c₀ and c₁. For example, c₀ can represent the least significant 384-bits, and c₁ can represent the most significant 384-bits resulting from the multiplication of integers A and B. Thus, C can be written as:

$$C = {\sum }_{i = 0}^{1} {{c}_{i} ( {2}^{384} )}^{i} \qquad ( 4 )$$

Item (3) can be substituted into item (4) with the result (modulo p):

C=c₀+c₁·x mod p (5)

After the first operation, large integer C is stored in accumulator 480. For simplicity, let S represent the value of accumulator 480. As illustrated, the lower order accumulator bits s₀=c₀ are coupled to one input of adder 470 and the higher order bits s₁=c₁ are coupled to one input of second multiplexer 420. In preparation for another operation, state machine 430 can produce control signals to select the value of c₁ at second multiplexer 420 and the value of x at third multiplexer 425.

Alternatively, as shown in dashed lines, c₀ can be provided at one input of first multiplexer 410 and c₁ can be provided at one input of second multiplexer 420 and a zero value can be stored in accumulator. For example, the product of the large integer multiplication (A×B=C) can be received from another stage in a processing pipeline or can be stored outside of accumulator 480 in a preceding operation. In that case, state machine 430 generates control signals with which to select the values of c₀ and c₁ at multiplexers 410, 420 prior to performing the next operation.

In a next operation, state machine 430 causes multiply-accumulate block 405 to process its inputs. As a result, multiplier 460 multiplies c₁ by the value of x. Adder 470 sums the product c₁·x and the value c₀ and stores the result c₀+c₁·x in accumulator 480. Note that these operations may be performed as a sequence of operations under control of state machine 430 or as a single, combined operation. In an exemplary embodiment, multiply-accumulate block 405 performs a high-speed multiply-add-accumulate operation in response to a single instruction from state machine 430.

In the present example, c₁ is a 384 bit number and x is a 129 bit number. Thus, c₁·x will be up to a 513 bit number. When added to c₀, it could be a 514 bit number with the carry. Thus, following the multiply-accumulate operation, the accumulator will hold a value of S as follows:

$$\begin{matrix}S = {c}_{0} + {c}_{1} \cdot x & ( 6 ) \\ S = {\sum }_{i = 0}^{1} {{s}_{i} ( {2}^{384} )}^{i} , {s}_{0} = {c}_{0} and {s}_{1} = {c}_{1} . & ( 7 )\end{matrix}$$

In preparation for a next operation, state machine 430 produces control signals which change the select inputs at first multiplexer 410 and second multiplexer 420. Responsive to the control signals, first multiplexer 410 presents a zero value (‘0’) to multiply-accumulate block 405 and the higher order accumulator bits, s₁, are fed back from accumulator 480 to second multiplexer 420. In the example where p is a 384-bit number, s₁ includes all bits above the 384th bit position. At this point, s₁ will be up to 130 bits (514−384=130). s₀ includes the least significant accumulator bits (those not included in s₁). The partition of accumulator value S into its higher and lower order bits can be based on the number of bits in prime modulus value p. Thus, if p were a 256 bit number, so could include the lower 256 bits of S and s₁ could include any remaining accumulator bits above s₀.

In a next operation, state machine 430 generates control signals for selecting the value of s₁ at the second multiplexer 420 and the ‘0’ value input at the first multiplexer 410. Also, remaining bits s₀ are delivered to adder circuit 470 as part of a three-way addition. State machine 430 again causes multiply-accumulate block 405 to process its inputs. As a result, the value of s₁ is multiplied by x, the product is added to the s₀ bits, and the result is stored in accumulator 480. Note that, as previously mentioned, multiply-accumulate block 405 can perform the multiply-add-accumulate operations in response to a single instruction or as a series of separate operations under control of state machine 230. At this stage, accumulator 480 holds value S as follows:

S=s₀+s₁·x (8)

Accumulator 480 now stores a value that is close to the value of the result r with the possible exception that p needs to be subtracted a number of times so that the value of S is less than the value of p. For the present example, it can be demonstrated that at most two subtractions are required.

To verify that accumulator 480 holds the correct value of r, state machine 430 can store the value of the accumulator S in latch 450. State machine 430 can then produce control signals which change the select inputs at both first multiplexer 410 and second multiplexer 420. As a result, first multiplexer 410 can present the value −p to multiply-accumulate block 405. This value is the opposite of the prime modulus and may be expressed in two's-complement or like binary negative representation. Second multiplexer 420 can present the zero value ‘0’ to multiply-accumulate block 405 as multiplication is not required.

State machine 430 can cause multiply-accumulate block 405 to process its inputs. As a result, the value −p is added into accumulator 480 resulting in a new value of S. At this point, state machine 430 can cause comparator 440 to determine whether S has gone negative (S<0) as a result of the subtraction. If S<0, state machine 430 can signal that the large integer multiplication and modular reduction operation is complete and that the result r can be retrieved from latch 450. On the other hand, if S>0, state machine 430 can store the new value of S into latch 450 and can repeat the comparison until the value in the accumulator goes negative.

In one embodiment, before latching the value of S and adding the value of −p, state machine 430 detects whether the value in the accumulator 480 exceeds a predetermined threshold. If S is detected as being larger than the threshold value, state machine 430 can repeat the multiply-accumulate operation to further reduce the value of S in accordance with item (8). The threshold value can be detected, for example, if any non-zero bits remain in positions above the highest power of prime modulus p. In the previous example, if p has 384 bits, and if there are non-zero bits in the accumulator above the 384th bit, then state machine 430 can repeat the third operation instead of proceeding to add −p to the accumulator.

It will be recognized that hardware accelerator 400 can operate on different sized data and that data sizes can be varied within the scope of this disclosure. For example, in one embodiment, processor 220 can vary the size of the large integer values A, B and the prime modulus value p by setting corresponding values in state machine 430. State machine 430 can partition accumulator value S into the higher and lower order bits based on the size of prime modulus p. For example, if p is a 256 bit number, then state machine 430 can select the lower 256 bits in accumulator 480 as so and any bits above the 256th bit position as s₁.

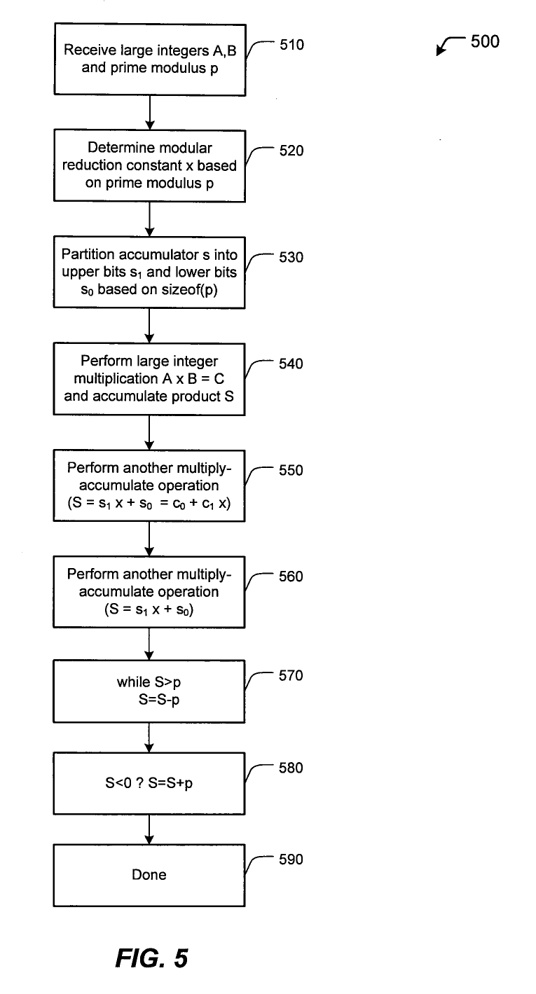

FIG. 5 is a flowchart depicting an embodiment of a process 500 such as can be performed by a hardware accelerator. In some embodiments, process 500 is carried out by hardware accelerator 400. At block 510, values are loaded at the hardware accelerator. An enable signal can be received at an external interface indicating that the large integers and a prime modulus value are available. For example, processor 220 can schedule hardware acceleration of select operations in a point double, point addition, or other elliptic curve operation.

Preferably, the hardware accelerator operates on arbitrary sized values up to its maximum specifications. For example, a hardware accelerator with 1042-bit multipliers and adders could receive 521-bit, 384-bit, 256-bit, or other size large integer values. In like manner, the prime modulus can be 521 bits, 384 bits, 256 bits, or some other size.

At block 520, a modular reduction constant x is determined from the prime modulus p. The value x can be based on the prime modulus p and can be obtained by subtracting p from the next highest power of two in its binary expansion. Thus, if p is a 384-bit number, x can be found by subtracting p from 2³⁸⁴, and if p is a 256-bit number, x can be found by subtracting p from 2²⁵⁶, and so on. Modular reduction constant x can be received at the external interface with the large integer values or it can be determined by the hardware accelerator based on the prime modulus.

To accommodate arbitrarily sized values, the accumulator can be divided into two groups based on the size of the prime modulus. In one embodiment, a number of accumulator bits equal to the size of p are designated for selection as a lower bit group s₀ while the remaining accumulator bits are designated for selection as an upper bit group s₁. Thus, if the prime modulus is a 384 bit number, the so bits would include the least significant 384 accumulator bits and the s₁ bits would include all remaining accumulator bits (the remaining most significant accumulator bits).

At block 540, the hardware accelerator performs the large integer multiplication A×B and stores the product C in the accumulator. In some embodiments, the hardware accelerator includes programmable logic with a dedicated multiply-accumulate circuit. Since addition is not required, a zero value can be added in connection with the first multiplication. In a series of additional operations, blocks 550-580, product C is modularly reduced by prime modulus p using the value of x determined in block 520.

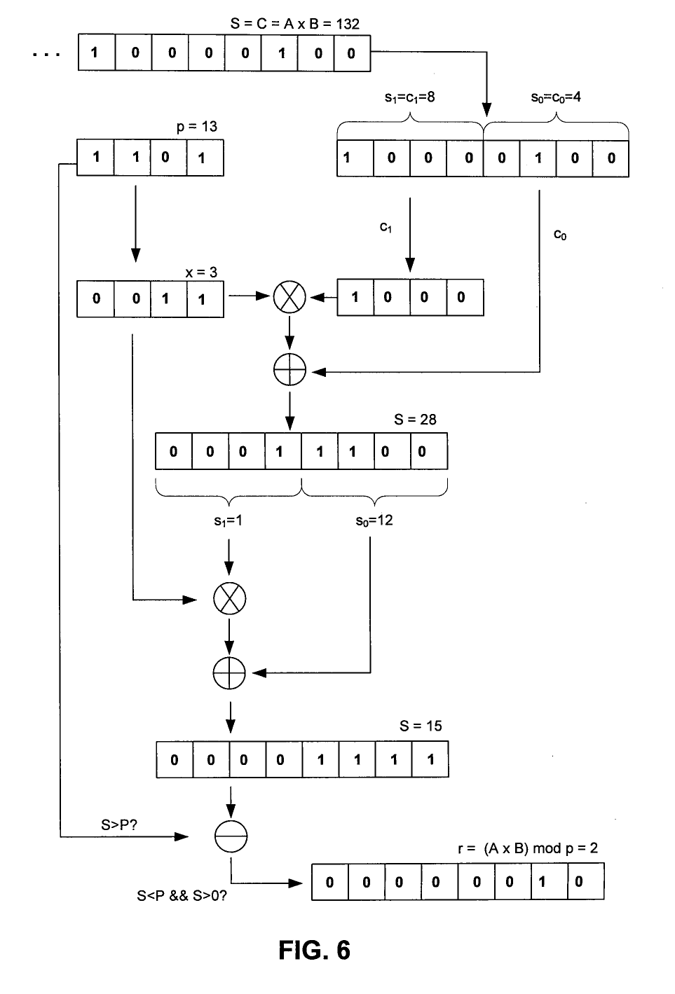

FIG. 6 provides an illustration of the modular reduction steps. For simplicity, let C equal 132 (8-bits) which can result from multiplying two four-bit numbers A×B (e.g., 11×12=132). The number 13 (4-bits) is selected as the exemplary prime modulus p. Note that p is not restricted to a particular size and that A and B can also be arbitrarily sized within the limits of the hardware accelerator.

As discussed in connection with block 530, the accumulator can be divided into two parts. In the present example, the lower bits so comprise the four least significant accumulator bits. The upper bits s₁ include all remaining bits. Here, p is a 4 bit value. Thus, at the start of the modular reduction, s₀=c₀=4 and s₁=c₁=8. Modular reduction constant x is determined by subtracting the prime modulus p from the next higher power of two (i.e., x=2⁴−p=3).

At block 550, in a first multiply-accumulate operation, upper bits s₁ are multiplied by x and lower bits so added to the product. The result of the multiply-accumulate is stored in the accumulator (S=28). At block 560, a second multiply-accumulate operation is performed on the accumulator value. In the second operation, upper bits s₁=1 are multiplied by x=3 and lower bits s₀=12 are added to the product. Following the second operation, the accumulator holds the value S=15.

In a next operation, blocks 570-580, the candidate value S is compared to prime modulus p to determine if it must be further reduced. Depending upon the relative size of A×B and p, it may be necessary to subtract the value of p from S one or more times to reach the result r. In the example, 15>13 and thus p is subtracted from S to yield a new candidate value r=2. In a next check, it is determined that 2<13 and 2>0. Accordingly, the modular reduction is completed at block 590 and the result r=A×B mod p is available in the accumulator. If S<0 then p could be added back in a separate operation. Alternatively, as shown in FIG. 4, a copy of S could be made for each candidate value after the second multiply-accumulate operation. The candidate value could be released if the additional subtraction caused the accumulator to go negative.

If the accumulator value S is very large relative to p, many subtraction operations would be required to reach the condition S<p. To avoid this situation, the first and second multiply-accumulate operations (blocks 550-560) could be repeated. In one embodiment, a state machine of the hardware accelerator determines whether the first and second multiply-accumulate operations should be repeated by comparing clock cycles. For example, if the multiply-accumulate operations require a total of 80 clock cycles and each subtraction requires 10 clock cycles, then it would be efficient to repeat the multiply-accumulate operations when more than 8 subtractions are required to reach the condition S<p. By comparing the upper-most bits in the accumulator to a threshold value, the state machine can choose the most efficient alternative.

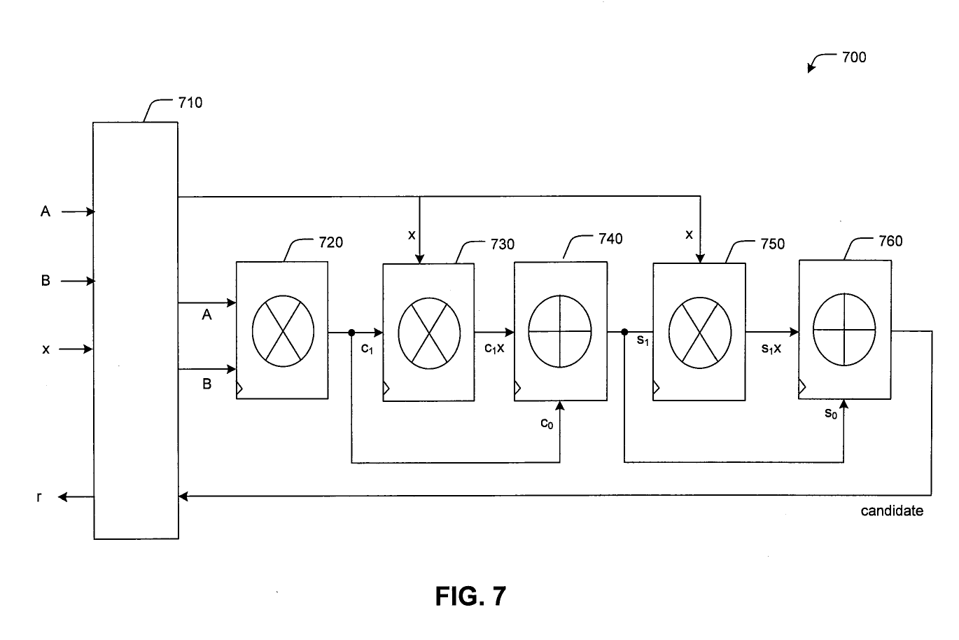

FIG. 7 is a block diagram of a further embodiment of a hardware accelerator. Hardware accelerator 700 utilizes the same multiplication and modular reduction techniques as described in connection with FIGS. 4-6, but a pipelined architecture replaces the state machine. Data can move between the stages of the pipeline according to a clock signal such that, at predetermined times, new values enter the pipeline and existing values propagate toward the last stage at which operations are complete.

As shown, processing values are received at an input/output interface 710 of hardware accelerator 700. The inputs can be as previously described with A and B representing large integer values, and x representing the modular reduction constant. The output, r, is a candidate value for the result of A×B mod p. In this embodiment, comparison with the prime modulus p is performed externally and thus input of the prime modulus value is not required. However, in some embodiments, one or more additional pipeline stages are appended to the pipeline for subtracting the prime modulus to achieve a fully reduced result.

A first pipeline stage 720 is coupled to the interface 710 and receives values of A and B at its inputs. First pipeline stage 720 includes a multiplier circuit and the product of C=A×B is presented at the output. Output C is divided into upper bits c₁ and lower bits c₀ as previously discussed. A second pipeline stage 730 is coupled to the first pipeline stage 710 and receives upper bits c₁ at one of its input. Second pipeline stage 730 is also coupled to interface 710 and receives modular reduction constant x at another of its inputs. Second pipeline stage 730 multiplies its inputs to generate the value c₁·x at its output.

A third pipeline stage 740 is coupled to second pipeline stage 730 and receives the product of c₁·x. Third pipeline stage 740 is also coupled to first pipeline stage 720 and receives lower bits c₀ at another of its inputs. Third pipeline stage 740 includes an adder circuit that adds its input values and delivers the sum c₀+c₁·x at its output.

The output of third pipeline stage 740 is divided into upper bits s₁ and lower bits so as previously discussed. A fourth pipeline stage 750 is coupled to third pipeline stage 740 and receives upper bits s₁ at one of its inputs. Fourth pipeline stage 750 is also coupled to interface 710 and receives x at another of its inputs. Fourth pipeline stage 750 multiplies its inputs to generate value s₁·x at its output.

A fifth pipeline stage 760 is coupled to fourth pipeline stage 750 and receives the product of s₁·x. Fifth pipeline stage 760 is also coupled to third pipeline stage 740 and receives lower bits so at another of its inputs. Fifth pipeline stage 760 includes an adder circuit that adds its input values and delivers the sum s₀+s₁·x at its output. The output of the fifth pipeline stage is coupled to interface 710 so that the candidate value of r is returned each time the pipeline is fully processed.

Specific details are given in the above description to provide a thorough understanding of the embodiments. However, it is understood that the embodiments may be practiced without these specific details. For example, some circuits may be omitted from block diagrams in order not to obscure the embodiments with unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, or a combination of hardware and software. For a hardware implementation, processing units may be implemented with one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented in a combination of hardware, software, firmware, middleware, microcode, and hardware description languages. When implemented in firmware, middleware, scripting language, and/or microcode, the program code or code segments to perform the necessary tasks may be stored in a machine readable medium such as a storage medium. A code segment or machine-executable instruction may represent a procedure, a function, a module, a routine, a subroutine, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

What is claimed is:

1. A hardware accelerator comprising:
an accumulator configured to store a plurality of bits of a large integer value corresponding to a multiply operation of the hardware accelerator, the plurality of bits comprising first bits and second bits;
a first multiplexer configured to receive the first bits of the accumulator at one input and to supply a first value at its output;
a multiplier circuit configured to generate a product by multiplying the first value by a modular reduction constant corresponding to a prime modulus;
an adder circuit configured to add the second bits of the accumulator to the product to produce a sum, wherein the sum is stored in the accumulator; and
a state machine coupled to a select input of the first multiplexer and configured to control a successive operation of the multiplier circuit and the adder circuit, and to determine when a value of the accumulator comprises a modular reduction of the large integer value by the prime modulus.

2. The hardware accelerator of claim 1, wherein the first bits and the second bits are determined according to a size of the prime modulus.

3. The hardware accelerator of claim 1, wherein the first bits comprise a plurality of most significant bits of the large integer value and the second bits comprise a plurality of least significant bits of the large integer value.

4. The hardware accelerator of claim 3, wherein the state machine defines a first operation of the hardware accelerator in which the most significant bits of the large integer value are selected at said one input of the first multiplexer and wherein the sum produced by the adder circuit comprises the least significant bits of the large integer value added to the product of the most significant bits and the constant of the modular reduction.

5. The hardware accelerator of claim 4, wherein the first bits and the second bits of the accumulator correspond to a result of the first operation, and wherein the state machine defines a second operation of the hardware accelerator in which the first bits are selected at said one input of the first multiplexer, and the sum produced by the adder circuit comprises the second bits added to the product of the first bits and the constant of modular reduction.

6. The hardware accelerator of claim 5, further comprising:
a comparator having one input configured to receive the prime modulus and another input configured to receive the value of the accumulator, and
a register configured to store the value of the accumulator.

7. The hardware accelerator of claim 6, wherein based on the result of the comparison the state machine defines a third operation of the hardware accelerator in which the adder subtracts the prime modulus value from the value of the accumulator.

8. The hardware accelerator of claim 6, wherein based on the result of the comparison the state machine repeats the first and second operations.

9. The hardware accelerator of claim 1, wherein the accumulator, multiplier circuit, adder circuit, and state machine are disposed on a programmable logic device.

10. The hardware accelerator of claim 9, wherein the programmable logic device comprises a field-programmable gate array (FPGA).

11. The hardware accelerator of claim 9, wherein the programmable logic device further comprises a dedicated multiply-accumulate block and wherein the adder circuit, the multiplier circuit, and the accumulator are included as part of the multiply-accumulate block.

12. The hardware accelerator of claim 1, wherein the large integer value is generated as part of a key agreement process.

13. The hardware accelerator of claim 1, wherein the modular reduction constant comprises a difference between the prime modulus and a number that is a next higher power of two.

14. A method of accelerating cryptographic operations with a programmable logic device having multiplier, adder, and accumulator circuits, comprising:
multiplying two large integer values with the multiplier circuit;
storing a result of the multiplication in the accumulator;
receiving a modular reduction constant corresponding to a prime modulus value;
selecting first bits of the accumulator based on a size of the prime modulus value;
multiplying the first bits by the modular reduction constant with the multiplier and adding thereto second bits of the accumulator with the adder in a first operation;
storing a result of the first operation in the accumulator;
selecting first bits of the result based on the size of the prime modulus value;
multiplying the first bits of the result by the modular reduction constant with the multiplier and adding second bits of the result thereto with the adder in a second operation;
storing a result of the second operation in the accumulator;
comparing the prime modulus value to the accumulator; and
subtracting the prime modulus value from the accumulator when a value of the accumulator is larger than the prime modulus value.

15. A programmable logic device, comprising:
a dedicated multiply-accumulate circuit;
a first multiplexer coupled to a first input of the multiply-accumulate circuit and configured to receive high-order bits of a large integer at one input;
a second multiplexer coupled to a second input of the multiply-accumulate circuit and configured to receive low-order bits of the large integer value at one input;
a state machine coupled to select inputs of the first and second multiplexers and configured to select the high-order bits and the low-order bits,
wherein the state machine is configured to control the multiply-accumulate circuit in a first operation to multiply the high-order bits by a modular reduction constant and add a product of the multiply to the low-order bits to produce an accumulated value, and in a second operation to multiply first selected bits of the accumulated value by the modular reduction constant and add a result of the second operation to second selected bits of the accumulated value, and in a third operation to subtract a prime modulus value from accumulated value when the accumulated value is larger than the prime modulus value, whereby the accumulated value comprises a modular reduction of the large integer by a prime modulus value associated with the constant of modular reduction.

16. The programmable logic device of claim 16, wherein the first selected bits and the second selected bits are determined according to a size of the prime modulus value.

17. The programmable logic device of claim 16, wherein the modular reduction constant comprises a difference between the prime modulus value and a number that is a next higher power of two.

18. A cryptographic accelerator comprising:
means for dividing a large integer into a first part and a second part based on a size of a modulus value;
means for multiplying in a first multiplication the first part of the large integer value by a modular reduction constant corresponding to the modulus value;
means for adding in a first addition the second part of the large integer value to a result of the first multiplication;
means for storing a result of the first addition;
means for selecting first bits of the stored result based on the size of the modulus value;
means for multiplying in a second multiplication the selected first bits by the modular reduction constant;
means for selecting second bits of the stored result based on the size of the modulus value;
means for adding in a second addition the selected second bits to a result of the second multiplication; and
means for subtracting one or more times the modulus value from a result of the second addition when the result of the second addition exceeds the modulus value.

19. A pipelined hardware accelerator circuit comprising:
an input/output interface configured to receive first and second large integers and a modulus value;
a first pipeline stage coupled to the input/output interface and comprising a multiplier circuit configured to generate an output by multiplying the first large integer by the second larger integer;
a second pipeline stage coupled to the first pipeline stage and comprising a multiplier circuit configured to generate an output by multiplying a first part of the output of the first pipeline stage by a modular reduction constant;
a third pipeline stage coupled to the first and second pipeline stages and comprising an adder circuit configured to generate an output by adding a second part of the output of the first pipeline stage to the output of the second pipeline stage;
a fourth pipeline stage coupled to the third pipeline stage and comprising a multiplier circuit configured to generate an output by multiplying a first part of the output of the third pipeline stage by the modular reduction constant; and
a fifth pipeline stage coupled to the third and fourth pipeline stages and comprising an adder circuit configured to add the output of the fourth pipeline stage to a second part of the output of the third pipeline stage.

20. The pipelined hardware accelerator circuit of claim 19, further comprising a sixth pipeline stage configured to subtract the modulus value from the output of the fifth pipeline stage.

21. The pipelined hardware accelerator circuit of claim 19, wherein the pipeline stages are configured to operate synchronously with a clock signal.

22. The pipelined hardware accelerator circuit of claim 21, wherein the input/output interface is configured to receive new large integer values for modular reduction at each predetermined number of clock cycles.
